(19) United States
(12) Patent Application Publication
(10) Pub. No.: US 2017/0287024 A1
(43) Pub. Date: Oct. 5, 2017

(54) PERSON TO PERSON AND SOCIAL NETWORK ELECTRONIC TRANSACTIONS USING RICH MEDIA

(71) Applicant: PAYPAL, INC., San Jose, CA (US)

(72) Inventor: Damon Bakun, San Jose, CA (US)

(21) Appl. No.: 15/089,171

(22) Filed: Apr. 1, 2016

(51) Int. Cl. G06Q 30/06; G06Q 20/32; H04L 12/58

(52) U.S. Cl. CPC G06Q 30/0601; H04L 51/32; H04L 51/10; G06Q 20/32; G06Q 50/01

(57) ABSTRACT

Systems and methods for providing payment request management includes receiving, through a network from a first sender device associated with the first sender, a payment request associated with the first sender and a receiver. A personalization configuration associated with the payment request is determined. A personalized payment message is received through the network from the first sender device according to the personalization configuration. The personalized payment message is stored in association with the payment request. The payment request with the personalized payment message is communicated through the network to a receiver device associated with the receiver to cause a display of the payment request and playing of the personalized payment message on the receiver device.

### BACKGROUND

The present disclosure generally relates to payment systems used over electronic networks and more particularly to a payment system that generates personalized payment messages for payment requests.

More and more consumers are conducting transactions, such as purchasing items and services, over electronic networks such as, for example, the Internet. Consumers routinely purchase products and services from merchants and individuals alike. The transactions may take place directly between a physical or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Some payment service providers offer person-to-person payment services, allowing users to send payment requests (e.g., for sending money or requesting money) to other users.

However, such payment requests between users typically are impersonal and can be awkward. Embodiments described herein provide for a system for allowing users to send payment requests over the electronic networks with a more personal and delightful experience.

### BRIEF DESCRIPTION OF THE FIGURES

FIG. 1 is a flow chart illustrating an embodiment of a method for providing payment requests with personalized payment messages;

FIG. 2 is a screen shot illustrating an embodiment of a first sender device displaying a payment request screen;

FIG. 3 is a screen shot illustrating an embodiment of a first sender device displaying a group payment request screen;

FIG. 4A is a screen shot illustrating an embodiment of a first sender device displaying a personalization configuration management screen;

FIG. 4B is a screen shot illustrating an embodiment of a first sender device displaying a group music video configuration management screen;

FIG. 5A is a screen shot illustrating an embodiment of a first sender device displaying an individual video content generation screen;

FIG. 5B is a screen shot illustrating an embodiment of a first sender device displaying an individual note content generation screen;

FIG. 5C is a screen shot illustrating an embodiment of a first sender device displaying a group music video content generation screen;

FIG. 5D is a screen shot illustrating an embodiment of a first sender device displaying a group music video content generation screen;

FIG. 6A is a screen shot illustrating an embodiment of a first sender device displaying a personalized message completion notification screen;

FIG. 6B is a screen shot illustrating an embodiment of a first sender device displaying an invitation sent screen;

FIG. 7A is a screen shot illustrating an embodiment of a second sender device displaying a group gift invitation notification screen;

FIG. 7B is a screen shot illustrating an embodiment of a second sender device displaying a group gift invitation details screen;

FIG. 8 is a screen shot illustrating an embodiment of a second sender device displaying a personalization configuration management screen;

FIG. 9 is a screen shot illustrating an embodiment of a second sender device displaying a group music video content generation screen;

FIG. 10A is a screen shot illustrating an embodiment of a system provider device displaying a personalized payment message generation screen;

FIG. 10B is a schematic illustrating an embodiment of a group music video message;

FIG. 11 is a screen shot illustrating an embodiment of a receiver device displaying a gift notification screen;

FIG. 12 is a screen shot illustrating an embodiment of a receiver device displaying a receiver response screen;

FIG. 13 is a schematic view illustrating an embodiment of a networked system;

FIG. 14 is a perspective view illustrating an embodiment of a sender device;

FIG. 15 is a schematic view illustrating an embodiment of a computer system; and

FIG. 16 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for providing a payment system that generates personalized payment messages. As discussed above, payment requests between users (e.g., friends) may be awkward and impersonal. To address such concerns, in embodiments of the systems and methods described herein, a system provider (e.g., the payment service provider discussed below) may allow the one or more senders of a payment request to include a personalized payment message. Such personalized payment messages may include audio content, video content, image content, music video content, or any other suitable multi-media content, and may make the payment experience more modern, less awkward, more personal, and generally more enjoyable. For a payment request associated with multiple senders (also referred to as a group payment request), each sender of the payment request may provide an individual personalized message. Those individual personalized messages may not be coordinated with each other, and the system provider may consolidate those individual personalized message to generate the personalized payment message. Moreover, a group personalization configuration for generating a group personalized message of the personalized payment message may be provided (e.g., by an initiator of the group payment request). Coordinated content may be provided by the senders of the group payment request according to the group personalization configuration. Such coordinated content may be consolidated according to the group personalization configuration to provide a group personalized message of the personalized payment message that is more coherent, consistent, and creative.

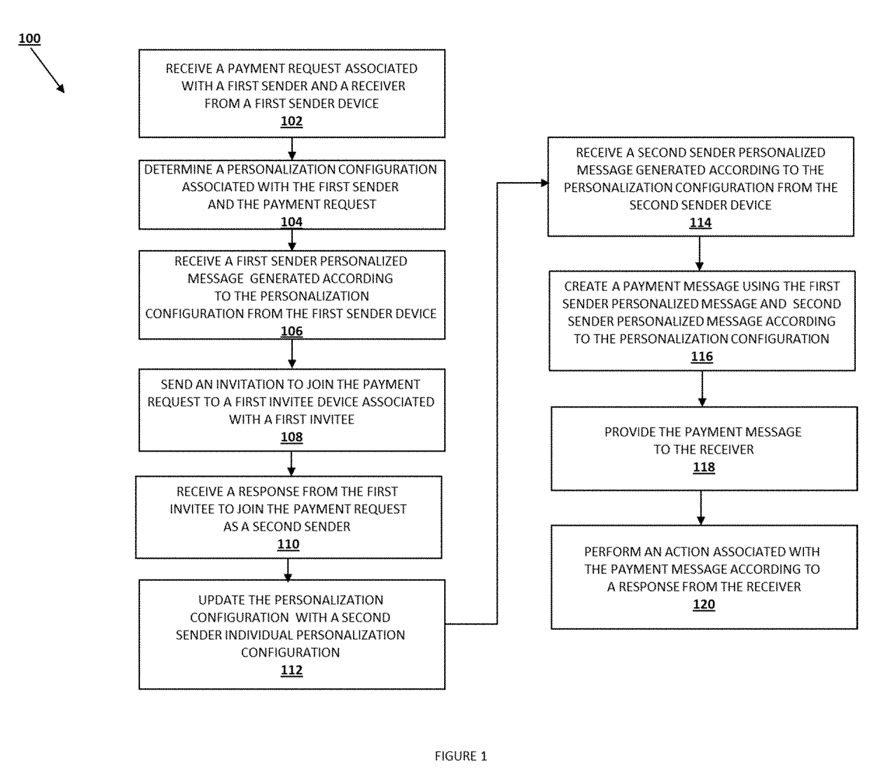

Referring to FIG. 1, an embodiment of a method 100 for providing payment requests with personalized payment messages is illustrated. In the embodiments discussed below, a payment service provider such as, for example, PayPal, Inc. of San Jose, Calif. is the system provider and operates a system provider device (e.g., payment service provider device) to help the senders generate personalized payment messages for payment requests. However, one of skill in the art in possession of the present disclosure will recognize that a variety of other system providers such as, for example, marketplace providers, merchants, financial service providers, marketing service providers, and/or other entities will benefit from the teachings herein and thus fall within the scope of the present disclosure.

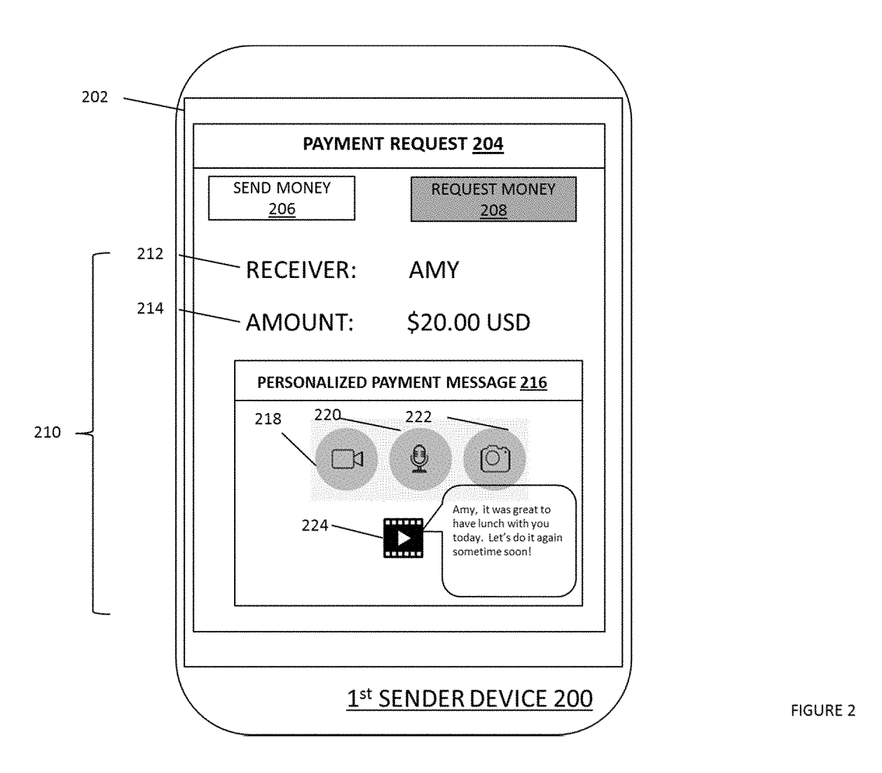

Referring to FIGS. 1, 2, and 3, the method 100 may begin at block 102, where the system provider receives a payment request from a first sender device. Referring to FIG. 2, illustrated is an example of a payment request screen 204 displayed on a display device 202 of a first sender device 200 associated with a first sender. In the particular illustrated example of FIG. 2, the first sender has selected the “REQUEST MONEY” button 208 to generate a payment request 210 for requesting money from a receiver. The payment request 210 includes a receiver 212 (e.g., “AMY,” an email address, a mobile number, or any other identifier of the receiver) and an amount 212 (e.g., “$20.00 USD”) provided by the first sender.

In some embodiments, the payment request screen 204 includes a personalized message section 216, where the first sender may generate a personalized payment message for the payment request 210. The first sender 310 may select one or more of content types 218, 220, and 222 to provide content of the selected content type(s). In an example, the first sender selects the content type 218 (e.g., video content type), and uses a video camera and/or a microphone of the first sender device 200 to record video content for the personalized payment message. In another example, the first sender selects the content type 220 (e.g., audio content type) to use a microphone of the first sender device 200 to record audio content for the personalized payment message. In yet another example, the first sender selects the content type 222 (e.g., photo content type) to use a camera of the first sender device 200 to take a photo or choose an existing photo (e.g., from the stored photos on the first sender device 200) for the personalized payment message. In the particular example of FIG. 2, the first sender selects the personalization option 218 and records video content 224. The video content 224 may include information related to the payment request 210 (e.g., “lunch with you today”) and/or any other personalized information.

In some embodiments, the first sender device 200 may submit the payment request 210 with a personalized payment message including the video content 224 to a receiver device associated with the receiver 212 (e.g., through a system provider device over a network).

In some embodiments, the first sender may select the “SEND MONEY” button 206 to generate a payment request for sending money to a receiver. A personalized payment message (e.g., including video, audio, photo, and/or content of other types) may be included in the payment request, which may be sent to the receiver (e.g., through a system provider device over a network).

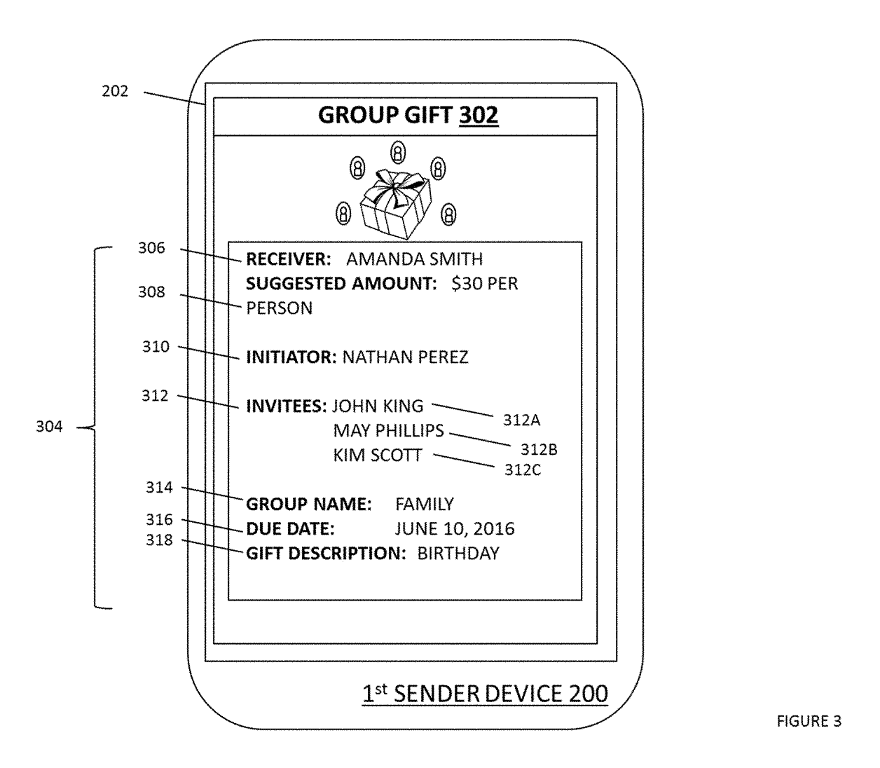

Referring to FIG. 3, in some embodiments, a payment request is associated with multiple senders (and/or multiple receivers), and such a payment request may also be referred to as a group payment request. In some examples, a group payment request is used to send a group gift to a receiver, and is also referred to as a group gift request. Illustrated in FIG. 3 is an example of a group gift screen 302 displayed on a display device 202 of a first sender device 200 associated with a first sender 310 (e.g., “NATHAN PEREZ”). The first sender 310 initiates the group gift request 304, and is also referred to as an initiator 310. The group gift request 304 includes information or data for a receiver 306 (e.g., “AMANDA SMITH”, an email address, a mobile number, or any other identifier of the receiver) that will receive the group gift, and a suggested contribution amount 308 (e.g., “$30.00 USD PER PERSON”).

In some embodiments, the initiator 310 identifies one or more invitees 312 that will be invited to join the group gift. In the particular example of FIG. 3, the invitees 312 include an invitee 312A (e.g., “JOHN KING”), an invitee 312B (e.g., “MAY PHILLIPS”), and an invitee 312C (e.g., “KIM SCOTT”). As described below, in subsequent steps, after a particular invitee accepts an invitation to join the group gift, the particular invitee is qualified as a sender of the group gift request.

In some embodiments, the group gift request 304 may include additional information associated with the group gift. In an example, the group gift 304 includes a group name 314 (e.g., “FAMILY”) providing information about the group invited to join to the group gift. In another example, the group gift request 304 includes a due date 316 (e.g., “JUNE 10, 2016”) indicating a date that the invitees need to respond to a group gift invitation to be included in the group gift. In yet another example, the group gift request 304 includes a gift description 318 (e.g., “BIRTHDAY”) explaining what the group gift is for.

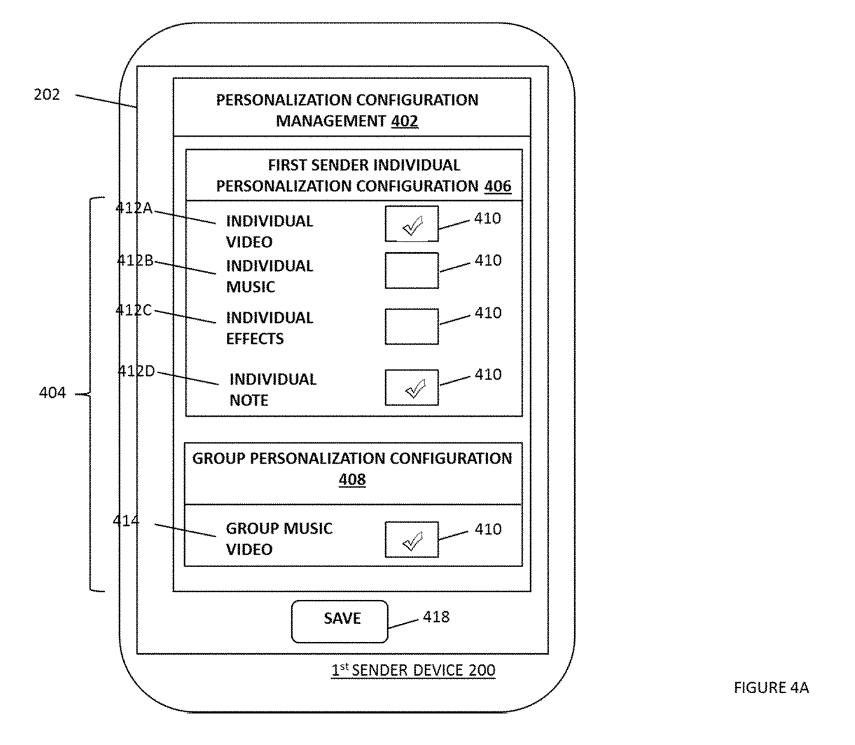

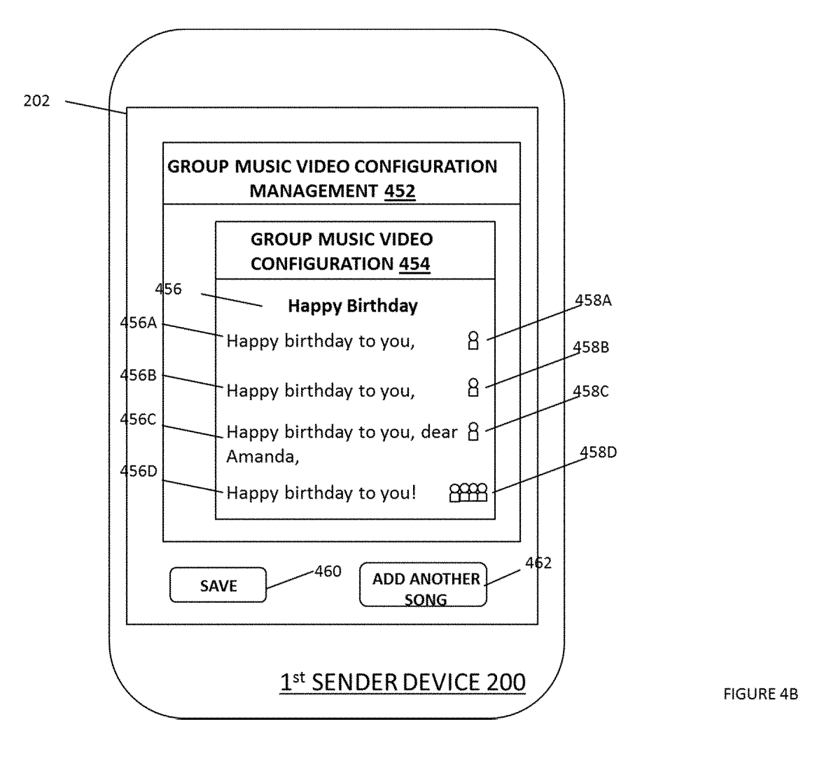

Referring to FIGS. 1, 4A, and 4B, the method 100 proceeds to block 104, where a personalization configuration associated with the first sender and the payment request is determined. Referring to FIG. 4A, illustrated is an example of a personalization configuration management screen 402 displayed on a display device 202 of the first sender device 200. The personalization configuration management screen 402 displays a personalization configuration 404 including a first sender individual personalization configuration 406, which may be used to configure an individual portion of a first sender personalized message in subsequent steps. In the example illustrated in FIG. 4A, the first sender 310 has selected the checkbox 410 for the content type 412A (e.g., “INDIVIDUAL VIDEO”), indicating that the first sender 310 may provide an individual video content. The first sender 310 has also selected the checkbox 410 for the individual content type 412D (e.g., “INDIVIDUAL NOTE”), indicating that the first sender 310 may provide an individual note content. On the other hand, the content types 412B (e.g., “INDIVIDUAL MUSIC”) and 412C (e.g., “INDIVIDUAL EFFECTS”) are not selected, indicating that the first sender 310 may not provide an individual music content or apply an individual effect (e.g., fades, dissolves, wipes, morphs, slow motion, fast motion, freeze-frame) in the individual portion of the first sender personalized message.

In some embodiments, the personalization configuration 404 includes a group personalization configuration 408, which may be used to configure a group portion of a first sender personalized message in subsequent steps. In the particular example illustrated in FIG. 4A, the first sender 310 has selected the content type 414 (e.g., “GROUP MUSIC VIDEO”), indicating the first sender 310 may provide music video content in the group portion of the first sender personalized message. The first sender 310 may select the “SAVE” button to save the personalization configuration 404 in a personalization configuration database coupled to the system provider device.

In some embodiments, the first sender 310 may provide a content type configuration associated with a particular content type. In an example, an individual video configuration may be provided for the content type 412A. In another example, an individual music configuration may be provided for the content type 412B. In another example, an individual effect configuration may be provided for the content type 412C. In yet another example, an individual note configuration may be provided for the content type 412D.

Referring to FIG. 4B, in some embodiments, the first sender 310 may provide a group music video configuration for the content type 414. Illustrated in FIG. 4B is an example of a group music video configuration management screen 452 displayed in a display device 202 of the first sender device 200. The group music video configuration management screen 452 displays a group music video configuration 454 which assigns different portions of a song 456 (e.g., “HAPPY BIRTHDAY”) to different senders of a group gift request, so that the different senders may provide coordinated music video content for a group music video content. In the example illustrated in FIG. 4B, assignment indicators 458A, 458B, 458C, and 458D provide that each of the portions 456A, 456B, and 456C of the song 456 may be assigned to a single sender, while the portion 456D of the song 456 is assigned to multiple senders (e.g., all senders of the group payment request). In some embodiments, the first sender 310 may select the “SAVE” button 460 to save the group music video configuration 454 in a personalization configuration database coupled to the system provider device. In some embodiments, the first sender 310 may select the “ADD ANOTHER SONG” button 462, add a new song, and provide another group music video configuration associated with the new song.

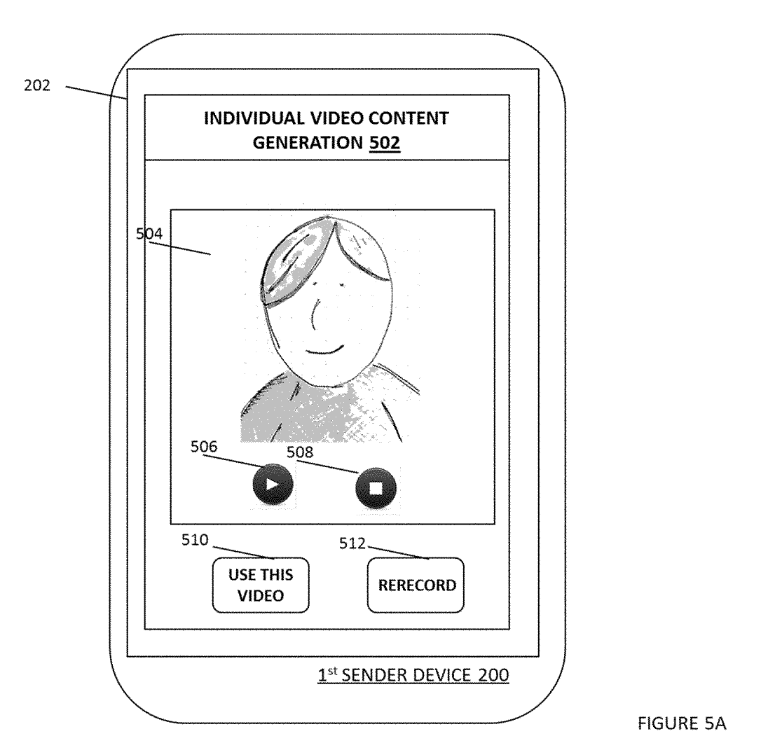

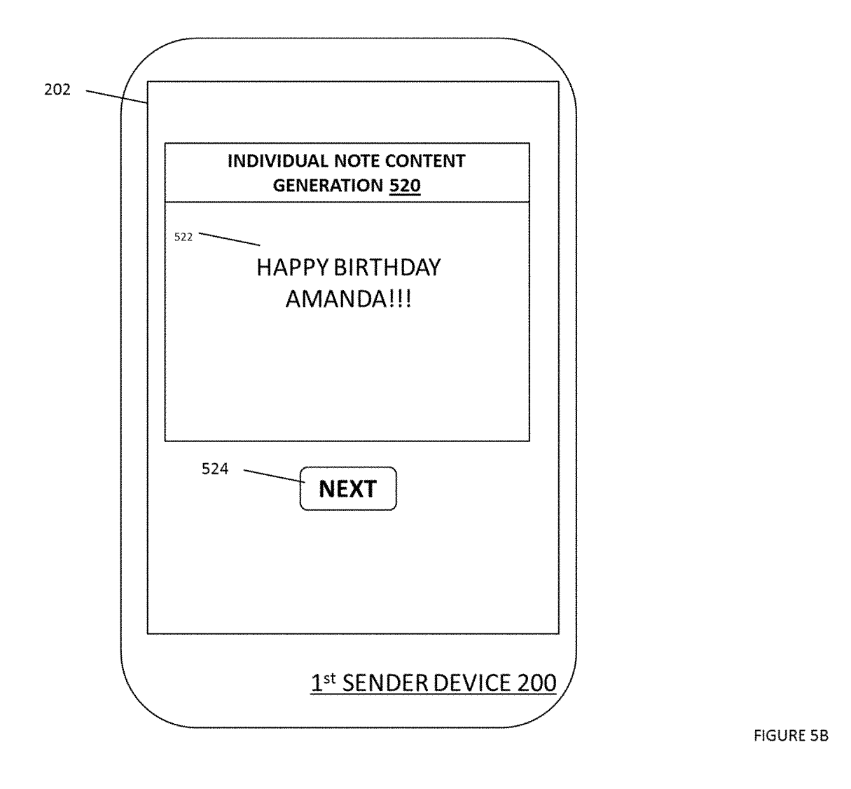

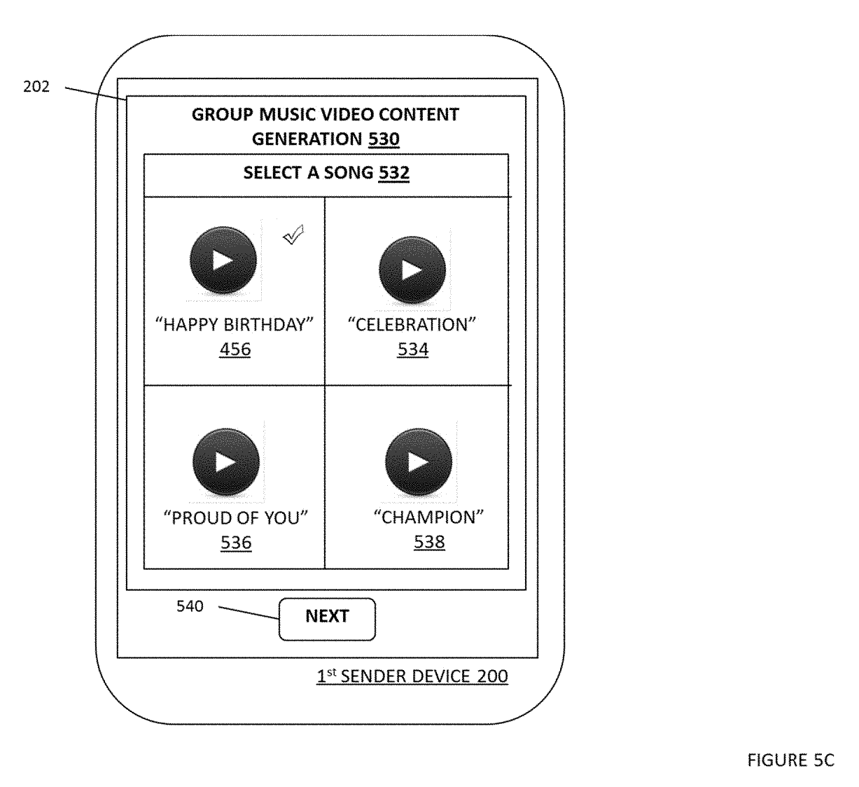

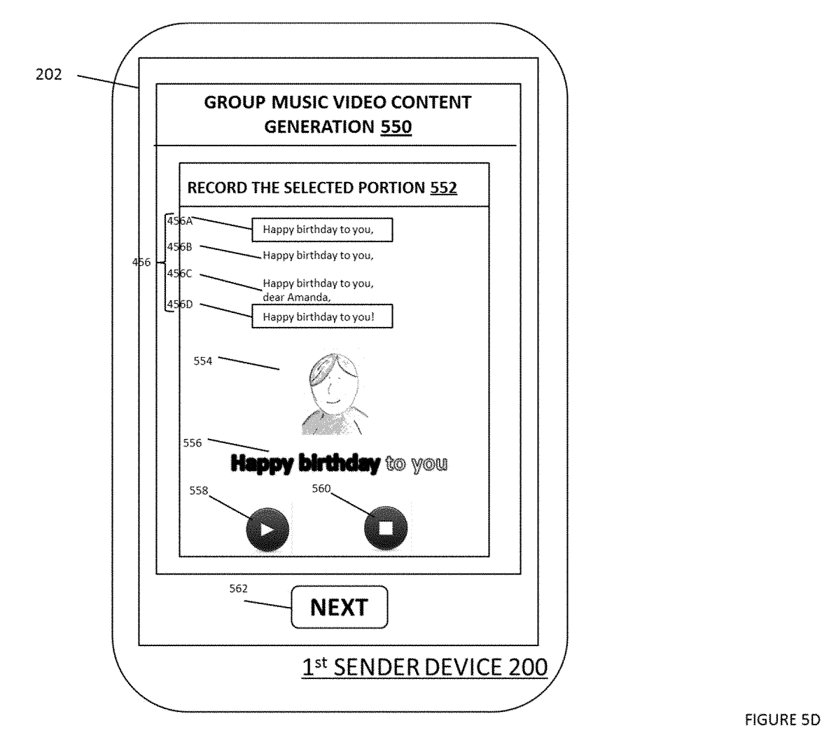

Referring to FIGS. 1, 5A, 5B, 5C, and 5D, the method 100 proceeds to block 106, where a first sender personalized message associated with the first sender and the group gift request is generated according to the personalization configuration. The first sender personalized message may then be sent to the system provider device by the first sender device 200.

Referring to FIG. 5A, in some embodiments, the system provider device determines that the individual personalization configuration 406 of the personalization configuration 404 includes a content type 412A (e.g., “INDIVIDUAL VIDEO”), and displays an individual video message generation screen 502 on a display device 202 of the first sender device 200. The individual video message generation screen 502 includes a video message section which allows the first sender 310 to record video content 504 using a video camera and/or a microphone of the first sender device 200. The first sender 310 may review the video content 504 by choosing the play button 506 and the stop button 508. In an example, the first sender 310 is satisfied with the video content 504, and selects the “USE THIS VIDEO” button 510 to go to the next step for generating the first sender personalized message. In another example, the first sender 310 is not satisfied with the video content 504, and selects the “RERECORD” button 512 to generate a new video message for the first sender personalized message.

Referring to FIG. 5B, in some embodiments, the system provider device determines that the first sender individual personalization configuration 406 of the personalization configuration 404 includes a content type 412D (e.g., “INDIVIDUAL NOTE”), and displays an individual note message generation screen 520 on a display device 202 of the first sender device 200. The individual note message generation screen 520 includes an individual note message 522 (e.g., “HAPPY BIRTHDAY AMANDA!!!”) provided by the first sender 310. After providing the individual note message 522, the first sender 310 may select the “NEXT” button 524 to go to the next step of generating the first sender personalized message.

Referring to FIG. 5C, in some embodiments, the system provider device determines that the group personalization configuration 408 of the personalization configuration 404 includes a content type 414 (e.g., “GROUP MUSIC VIDEO”), and displays a group music video content generation screen 530 on a display device 202 of the first sender device 200. The group music video content generation screen 530 may include a song selection section 532 including a list of songs from which the first sender 310 may select a song. In the example illustrated in FIG. 5C, the list of songs includes a song 456 (e.g., “HAPPY BIRTHDAY”), a song 534 (e.g., “CELEBRATION”), a song 536 (e.g., “PROUD OF YOU”), and a song 538 (e.g., “CHAMPION”). In the example of FIG. 5C, the first sender 310 chooses the song 456, and selects the “NEXT” button 520 to go to the next step of generating a group music video content of the first sender personalized message.

Referring to FIG. 5D, in some embodiments, after the first sender 310 selects a song for the content type 414, the system provider device retrieves (e.g., from a personalization configuration database coupled to the system provider device) a group music video configuration 454 associated with the selected song 456, and displays a group music video content generation screen 550 on a display device 202 of the first sender device 200. The group music video content generation screen 550 may include a song recording section 552 highlighting portions of the song 456 (e.g., portions 456A and 456D) assigned to the first sender 310 according to the group music video configuration 454. The first sender 310 may record a group music video content 554 for the selected portions 456A and 456D of the song 456 using a video camera and microphone of the first sender device 200 (e.g., using a karaoke style lyrics display 556 provided to the first sender 310). The first sender 310 may review the group music video content 554 using the play button 558 and the stop button 560, and then select the “NEXT” button 562 to go to the next step of generating the first sender personalized message.

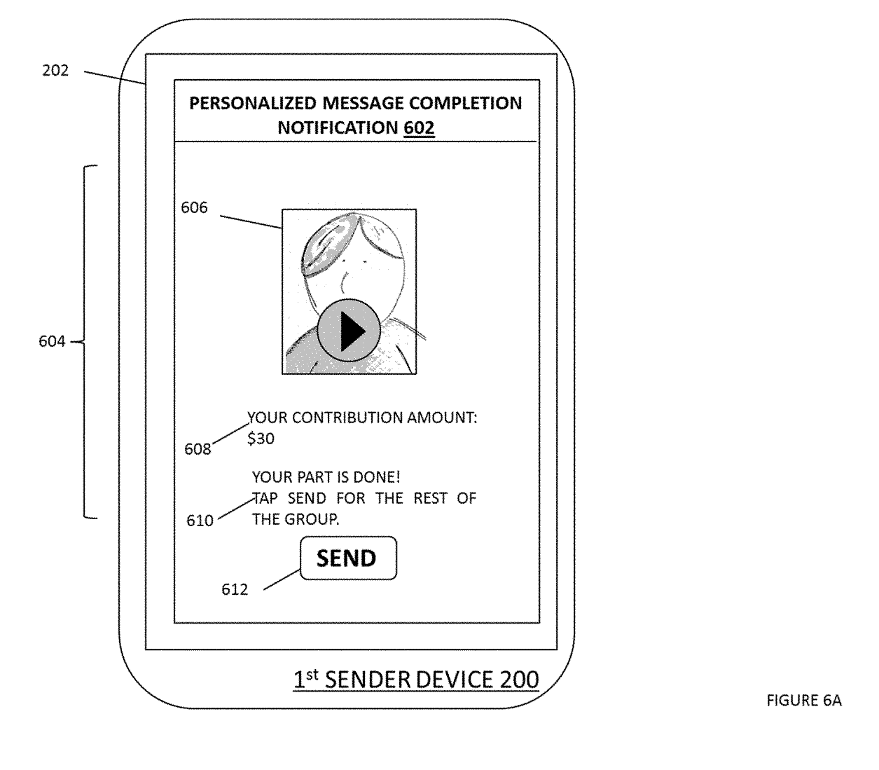

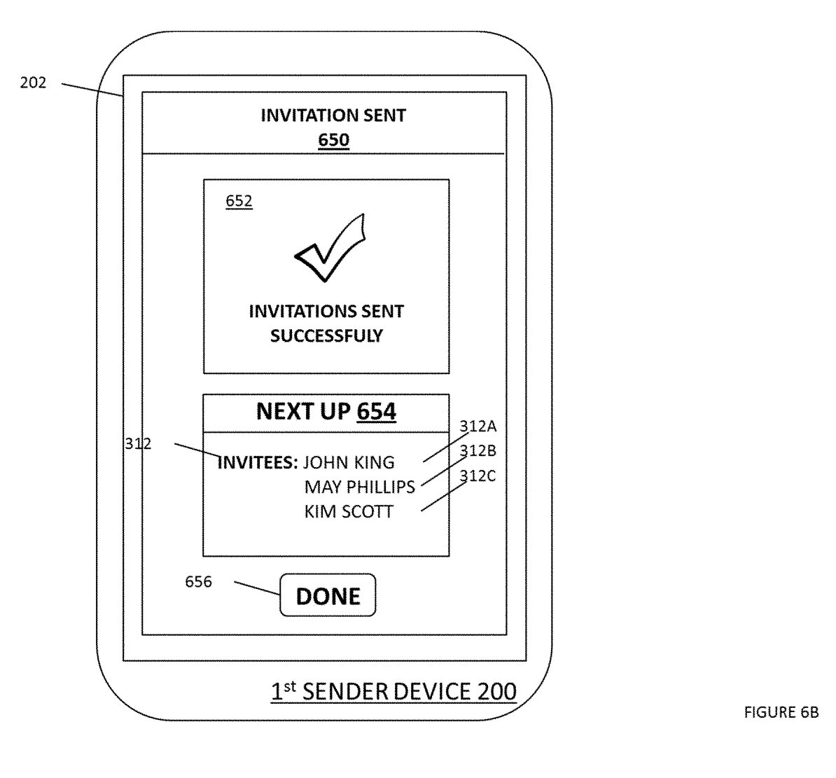

Referring to FIGS. 1, 6A, and 6B, the method 100 proceeds to block 108, where the system provider device determines that the first sender personalized message is completed, and sends invitations to join the group gift request to invitee devices.

Referring to FIG. 6A, in some embodiments, the system provider device determines the first sender 310 has completed the first sender personalized message according to the personalization configuration 404, and provides a personalized message completion notification to the first sender 310. Illustrated in FIG. 6A is a personalized message completion notification screen 602 displayed on a display device 202 of the first sender device 200, where a notification 604 is provided to the first sender. In some examples, the notification 604 includes a first sender personalized message 606 including the individual video content 504, the individual note content 522, and/or the group music video content 554. In some examples, the notification 604 includes a contribution amount 608 (e.g., “$30”) that the first sender 310 is contributing to the group gift. In some examples, the notification 604 includes a message 610 (e.g., “YOUR PART IS DONE! TAP SEND FOR THE REST OF THE GROUP”) reminding the first sender 310 to send invitations to join the group gift to invitees 312 of the group gift request 304. The first sender 310 may select the “SEND” button 612 to request the system provider device to send invitations for joining the group gift request to invitees 312.

Referring to FIG. 6B, after the system provider device sends invitations to the invitees of the group gift request, the system provider device provides an invitation sent notification to the first sender. Illustrated in FIG. 6B is an example of an invitation sent screen 650 displayed on a display device 202 of the first sender device 200. In some examples, the invitation sent screen 650 includes an invitations delivery status section 652 notifying the first sender 310 regarding the status of the invitations (e.g., “SENT SUCCESSFULLY”). In some examples, the invitation sent screen 650 includes a next up section 654 displaying the invitees (e.g., the invitees 312A, 312B, and 312C) that have received the invitations. The first sender 310 may select the “DONE” button 656 to acknowledge the reception of the invitation sent notification.

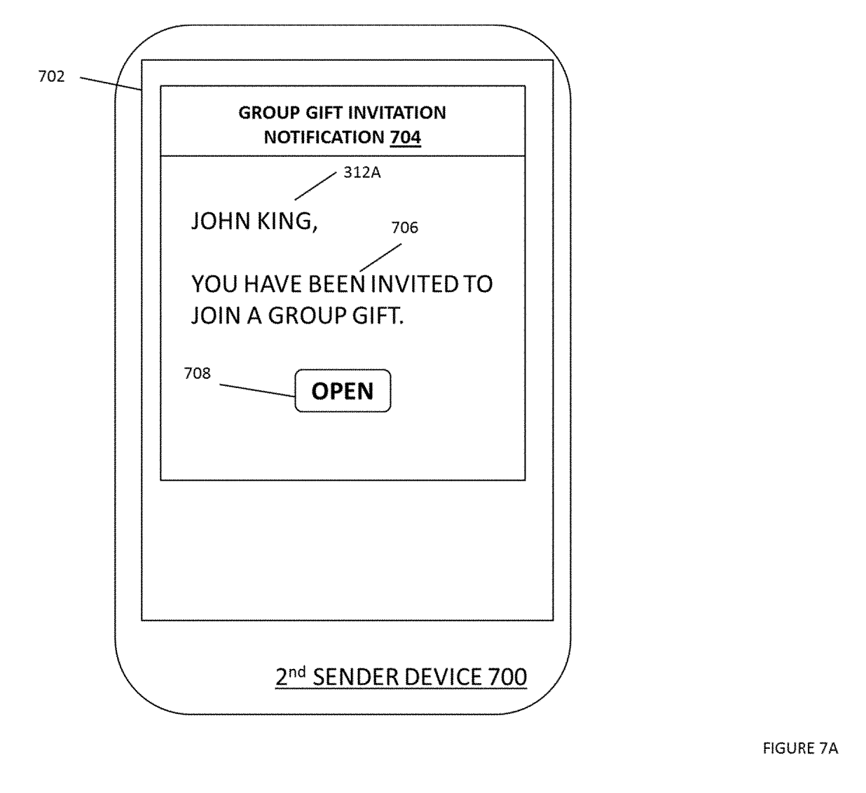

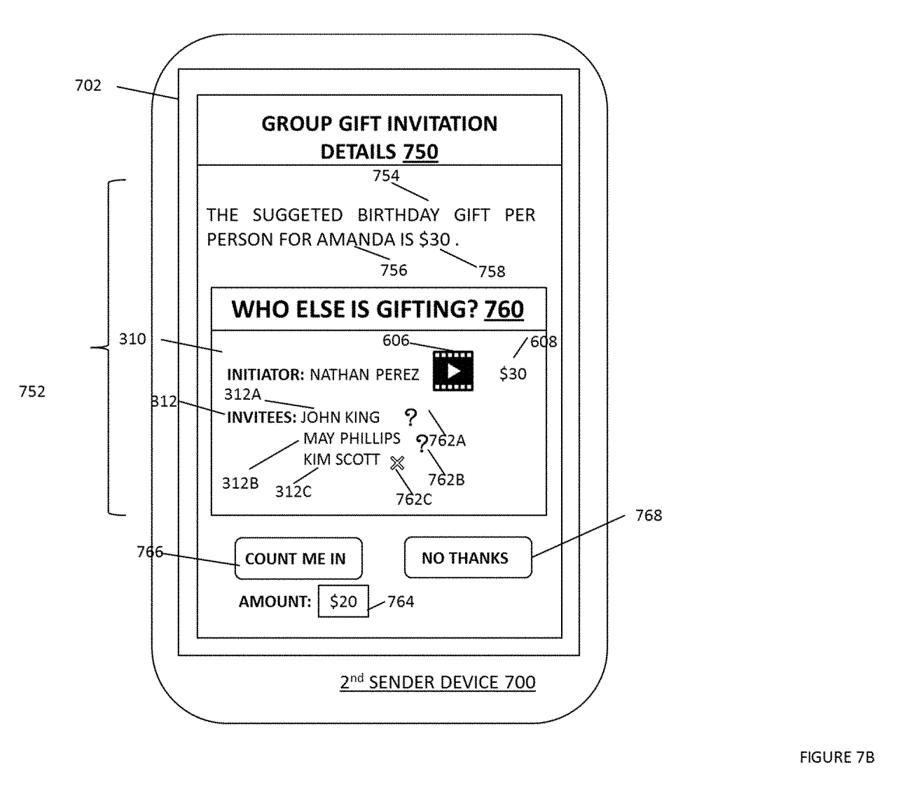

Referring to FIGS. 1, 7A, and 7B, the method 100 proceeds to block 110, where an invitee responds to the invitation and joins the group gift request as a second sender. Referring to FIG. 7A, illustrated is an example of a group gift invitation notification screen 704 displayed on a display device 702 of an invitee device 700. An invitee 312A (e.g., “JOHN KING”) receives a group gift invitation notification 706 notifying the invitee 312A about an invitation to join a group gift request. The invitee 312A may select the “OPEN” button 708 to review the details of the group gift invitation. The examples illustrated in FIG. 7A are not intended to be limiting, and the group gift invitation notification 706 may be provided to the invitee device 700 in a variety of manners (through a website, an application, as a message (e.g., an email, a text message, a picture message, a “pop-up”, a voice call, etc.)) without departing from the scope of the present disclosure.

Referring to FIG. 7B, after the invitee 312A selects the “OPEN” button 708 of FIG. 7A, the system provider device may provide group gift invitation information 752 on a group gift invitation details screen 750 displayed on a display device 702 of the invitee device 700. In some examples, the group gift invitation information 752 includes a gift description 754 (e.g., “BIRTHDAY GIFT”), receiver information 756 (e.g., “AMANDA”), and the suggested contribution amount 758 (e.g., “$30”). In some examples, the group gift invitation details screen 750 includes a status section 760 indicating who else is contributing to the group gift. For example, the status section 760 includes contribution status information for the first sender 310 and the invitees 312A, 312B, and 312C. In an example, the contribution status information for the first sender 310 includes a contribution amount 608 (e.g., “$30”) and a first sender personalized message 606. The invitee 312A may select and review the first sender personalized message 604. In another example, the contribution status information for the invitee 312C includes an opt-out status indicator 762C indicating that the invitee 312C chooses not to join the group gift. In yet another example, status indicators 762A and 762B for the invitees 312A and 312B indicate that the invitees 312A and 312B have not provided responses to the respective group gift invitation.

In some embodiments, the invitee 312A provides a contribution amount 764 (e.g., “$20”), and selects the “COUNT ME IN” button 766 to join the group gift request 304. In such embodiments, the invitee 312A becomes a second sender of the group gift request 304, and is hereafter referred to as the second sender 312A. Similarly, the invitee device 700 associated with the invitee 312A is hereafter referred to as the second sender device 700. Alternatively, in some embodiments, the invitee 312A selects the “NO THANKS” button 768 to opt out of the group gift request 304.

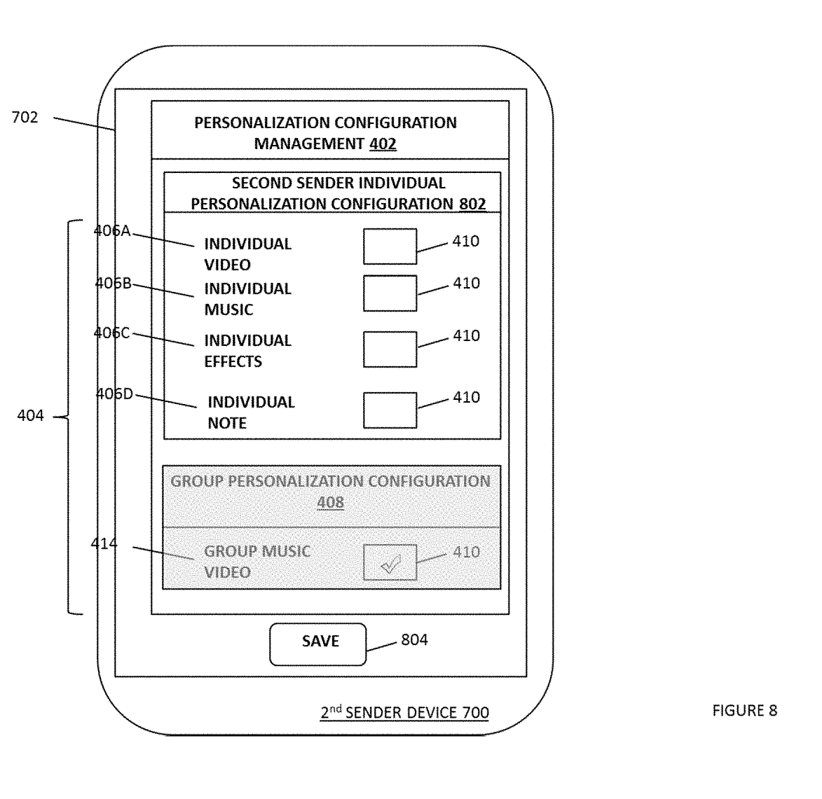

Referring to FIGS. 1 and 8, the method 100 proceeds to block 112, where the personalization configuration is updated with a second sender individual personalization configuration. Referring to FIG. 8, illustrated is an example of a personalization configuration management screen 402 displayed on a display device 702 of the second sender device 700. The personalization configuration management screen 402 displays the personalization configuration 404 including a second sender individual personalization configuration 802 for an individual portion of the second sender personalized message. In the example illustrated in FIG. 8, the second sender 312 does not choose any the content type for the second sender individual personalization configuration 802, indicating that the second sender 312A may not provide an individual portion in the second sender personalized message.

In some embodiments, the personalization configuration 404 includes a group personalization configuration 408 for a group portion of the second sender personalized message. In the example illustrated in FIG. 8, the group personalization configuration 408 includes a group music video configuration 414 provided by the first sender 310, which may not be changed by the second sender 312A. In some embodiments, the second sender 312A selects a “SAVE” button 804 to save the updated personalization configuration 404 in a personalization configuration database coupled to the system provider device.

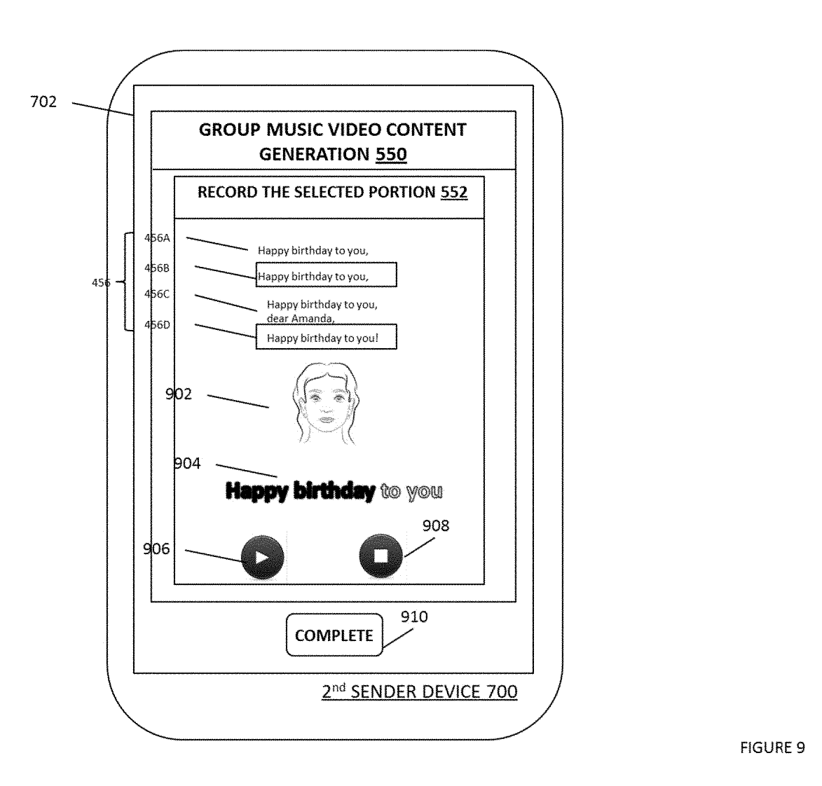

Referring to FIGS. 1 and 9, the method 100 proceeds to block 114, where the system provider device receives a second sender personalized message generated according to the personalization configuration 404 (including the second sender individual personalization configuration 802 and the group personalization configuration 408). In some embodiments, the system provider device determines that the second sender 312A may not provide any individual portion of the second sender personalized message according to the personalization configuration 404, and proceeds to prompt the send sender 312A to generate a group portion of the second sender personalized message. Referring to FIG. 9, illustrated therein is an example of a group music video content generation screen 550 displayed on a display device 702 of a second sender device 700. The group music video content generation screen 550 includes a song recording section 552 displaying the song 456 selected by the first sender 310. In the displayed song 456, the portions 456B and 456D assigned to the second sender 312A according to the group music video configuration 454 are highlighted. The second sender 312A may record group music video content 902 for the selected portions 456B and 456D of the song 456 using a video camera and microphone of the second sender device 700 (e.g., using a karaoke style lyrics display 904 provided to the second sender). The second sender 312A may review the performance 902 using the play button 906 and the stop button 908, and then select the “NEXT” button 910 to complete generating the second sender personalized message. In the particular example of FIG. 9, the second sender personalized message includes a group portion including the group music video content 902 and does not include an individual portion. In the discussion below, the second sender personalized message may also be referred to as the second sender personalized message 902.

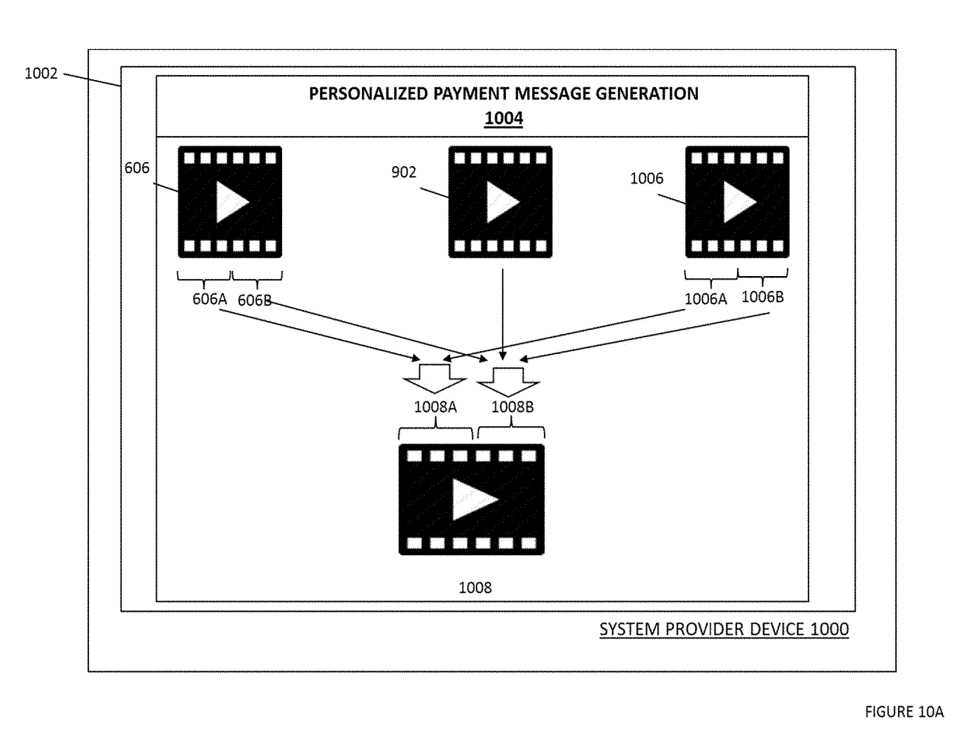

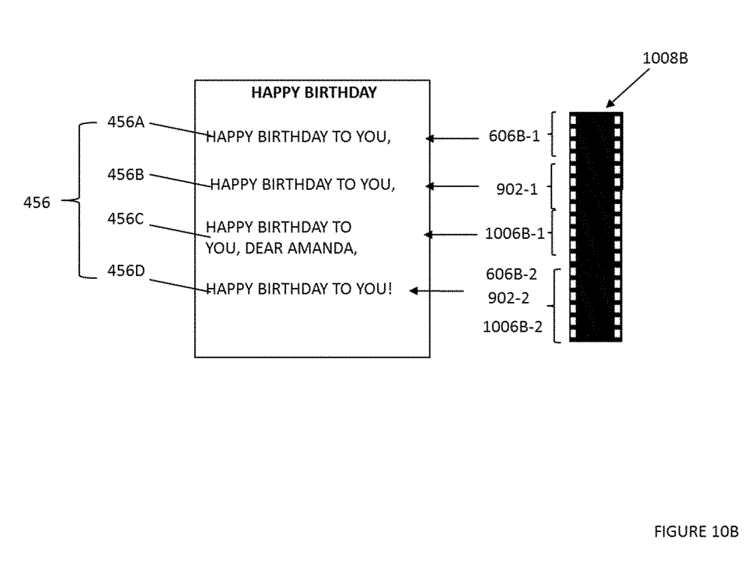

Referring to FIGS. 1, 10A, and 10B, the method 100 proceeds to block 116, where a system provider device 1000 generates a personalized payment message associated with the group gift request 304 using the first sender personalized message and the second sender personalized message according to the personalization configuration 404. Referring to FIG. 10A, illustrated is a personalized payment message generation screen 1004 displayed on a display device 1002 of a system provider device 1000. The personalized payment message generation screen 1004 displays a first sender personalized message 606 received from the first sender device 200 associated with the first sender 310, and a second sender personalized message 902 received from the second sender device 700 associated with the second sender 312A. In the example illustrated in FIG. 10A, the invitee 312B has accepted the group gift invitation, become a third sender 312B of the group gift request, and provided a third sender personalized message 1006 to the system provider device 100.

In some embodiments, the system provider device 1000 combines the individual portions of the personalized messages (e.g., the individual portion 606A of the first sender personalized message 606 and the individual portion 1006A of the third sender personalized message 1006) to generate a first portion 1008A of the payment message 1008. In some examples, the individual portion 606A and the individual portion 1006A are combined by joining the individual portion 1006A to the end of the individual portion 606A to generate the portion 1008A of the payment message 1008. In such examples, each of the individual portions 606A and 1006A is not split into smaller pieces for generating the portion 1008A of the payment message 1008.

In some embodiments, the system provider device 1000 combines the group portions of the personalized messages (e.g., the group portion 606B of the first sender personalized message 606, the second sender personalized message 902, and the group portion 1006B of the third sender personalized message 1006B) to generate a second portion 1008B of the payment message 1008. In some examples, the group portion 606B, the second sender personalized message 902, and the group portion 1006B of the third sender personalized message 1006B are combined by joining the second sender personalized message 902 to the end of the group portion 606B, and joining the group portion 1006B to the end of the second sender personalized message 902. In such examples, each of the group portions 606B, second sender personalized message 902, and 1006B is not split into smaller pieces for generating the portion 1008B of the payment message 1008.

Alternatively, referring to FIG. 10B, in some embodiments, the group portion 606B, the second sender personalized message 902, and the group portion 1006B of the third sender personalized message 1006B are combined according to the group music video configuration 454 to generate the portion 1008B of the payment message 1008. As illustrated in FIG. 10B, the system provider device 1000 may split the group portion 606B into a first part 606B-1 associated with the portion 456A of the song 456, and a second part 606B-2 associated with the portion 456D of the song 456. Similarly, the system provider device 1000 may split the second sender personalized message 902 into a first part 902-1 associated with the portion 456B of the song 456, and a second part 902-2 associated with the portion 456D of the song 456. The group portion 1006B may be split into a first part 1006B-1 associated with the portion 456C of the song 456, and a second part 1006B-2 associated with the portion 456D of the song 456. The parts 606B-1, 606B-2, 902-1, 902-2, 1006B-1, and 1006B-2 may be joined according to the group music video configuration 454. In a resulting group music video message 1008B, the first sender 310 sings the portion 456A, the second sender 312A sings the portion 456B, the third sender 312B sings the portion 456C, and all senders (e.g., including the first sender 310, the second sender 312A, and the third sender 312B) sing the portion 456D together (e.g., by mixing the sound tracks from the portions 606B-2, 902-2, and 1006B-2).

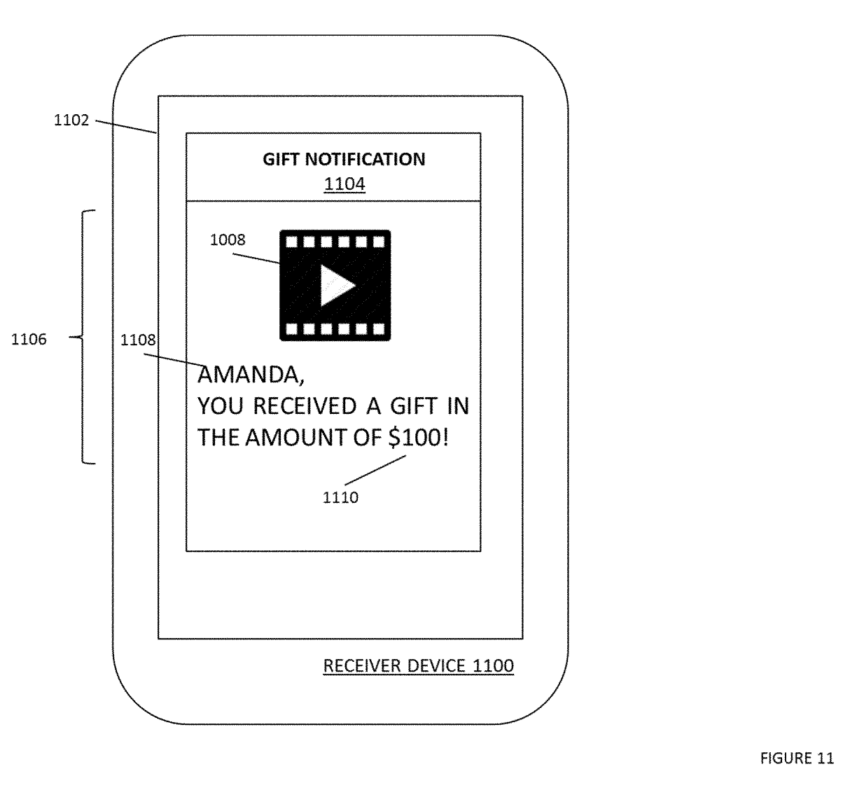

Referring to FIGS. 1 and 11, the method 100 proceeds to block 118, where a group gift notification is sent to a receiver device associated with the receiver. Referring to FIG. 11, illustrated therein is a gift notification screen 1104 displayed on a display device 1102 of a receiver device 1100 associated with a receiver 306 of the group gift request 304. The gift notification screen 1104 displays a gift notification 1106, which includes a personalized payment message 1008 that includes a first portion 1008A and a second portion 1008B (the group music video message 1008B), receiver information 1108 (e.g., “AMANDA”), and a group gift amount (e.g., “$100”). In some examples, the group gift amount 1110 is the total of the amounts contributed by all sender of the group gift request 304 (e.g., $30 from the first sender 310, $20 from the second sender 312A, and $50 from the third sender 312B).

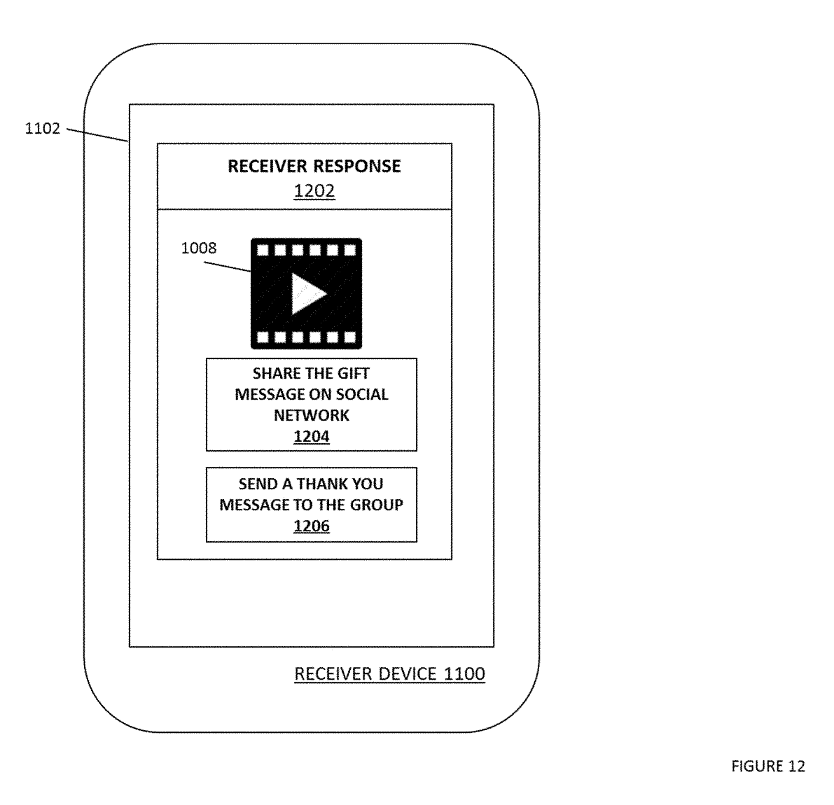

Referring to FIGS. 1 and 12, the method 100 proceeds to block 120, where the system provider device may perform an action associated with the group message according to a group gift response received from the receiver device. Referring to FIG. 12, illustrated therein is a receiver response screen 1202 displayed on a display device 1102 of a receiver device 1100. In an example, after reviewing the payment message 1008, the receiver 306 selects the “SHARE THE GIFT MESSGE ON SOCIAL NETWORK” button 1006 to post the personalized payment message 1008 on a social network (e.g., FACEBOOK®, SNAPCHAT®, INSTAGRAM®, TWITTER®). In another example, the receiver 306 selects the “SEND A THANK YOU MESSAGE TO THE GROUP” button 1206 to send thank you messages (e.g., through a website, an application, as an email, a text message, a picture message, a “pop-up”, a voice call, etc.) to senders of the group gift request 304.

Thus, systems and methods for providing payment request management have been described that operate to provide senders, receivers, and system providers a payment request management system that may provide payment requests (e.g., payment requests for sending money, requests for requesting money) with personalized payment messages. The personalized payment messages may include audio content, video content, image content, music video content, or any other suitable multi-media content. Such personalized payment messages may make the payment experience more modern, less awkward, more personal, and generally more enjoyable. Furthermore, the systems and methods allow a group payment request associated with multiple senders, where each sender may provide an individual personalized message to the personalized payment message. Moreover, a group personalization configuration for generating a group personalized message of the personalized payment message may be provided (e.g., by an initiator of the group payment request). Coordinated content may be provided by the senders of the group payment request according to the group personalization configuration. Such coordinated content may be consolidated according to the group personalization configuration to provide a group personalized message that is more coherent, consistent, and creative.

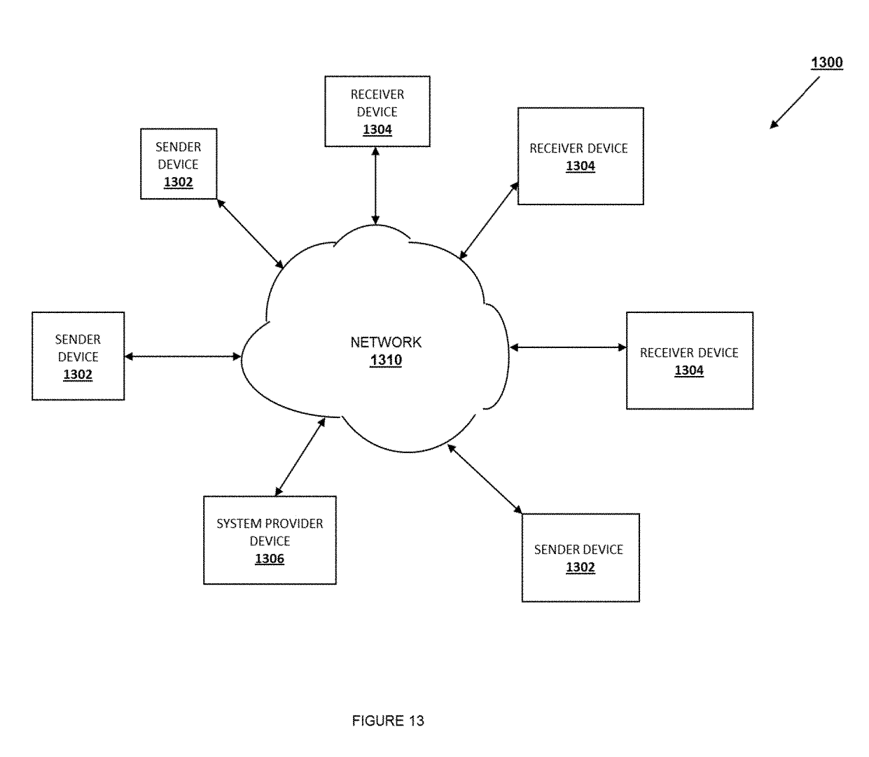

Referring now to FIG. 13, an embodiment of a network-based system 1300 for implementing one or more processes described herein is illustrated. As shown, network-based system 1300 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 10 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 1300 illustrated in FIG. 13 includes a plurality of sender devices 1302, a plurality of receiver devices 1304, and a system provider device 1306 in communication over a network 1310. Any of the sender devices 1302 may be the first sender device 200 and the second sender device 700 discussed above and used by the first sender and second sender discussed above. Any of the receiver devices 1304 may be the receiver device 1100 discussed above and used by the receiver 306 discussed above. The system provider device 1306 may be the system provider device 1000 discussed above and may be operated by a system provider such as, for example, PayPal Inc. of San Jose, Calif.

The sender devices 1302, receiver devices 1304, and system provider devices 1306 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 1300, and/or accessible over the network 1310.

The network 1310 may be implemented as a single network or a combination of multiple networks. For example, in various embodiments, the network 1310 may include the Internet and/or one or more intranets, landline networks, wireless networks, and/or other appropriate types of networks.

The sender device 1302 may be implemented using any appropriate combination of hardware and/or software configured for wired and/or wireless communication over network 1310. For example, in one embodiment, the sender device 1302 may be implemented as a personal computer of a user in communication with the Internet. In some embodiments, the sender device 1302 may be a wearable device. In some embodiments, the sender device 1302 may be a smart phone, personal digital assistant (PDA), laptop computer, and/or other types of computing devices.

The sender device 1302 may include one or more browser applications which may be used, for example, to provide a convenient interface to permit the customer to browse information available over the network 1310. For example, in one embodiment, the browser application may be implemented as a web browser configured to view information available over the Internet.

The sender device 1302 may also include one or more toolbar applications which may be used, for example, to provide user-side processing for performing desired tasks in response to operations selected by the customer. In one embodiment, the toolbar application may display a user interface in connection with the browser application.

The sender device 1302 may further include other applications as may be desired in particular embodiments to provide desired features to the sender device 1302. The other applications may also include security applications for implementing user-side security features, programmatic user applications for interfacing with appropriate application programming interfaces (APIs) over the network 1310, or other types of applications. Email and/or text applications may also be included, which allow the customer to send and receive emails and/or text messages through the network 1310. The sender device 1302 includes one or more user and/or device identifiers which may be implemented, for example, as operating system registry entries, cookies associated with the browser application, identifiers associated with hardware of the sender device 1302, or other appropriate identifiers, such as a phone number. In one embodiment, the customer identifier may be used by the system provider device 1306 to associate the customer with a particular account as further described herein. In various embodiments, the receiver device 1304 may be substantially similar to the sender device 1302.

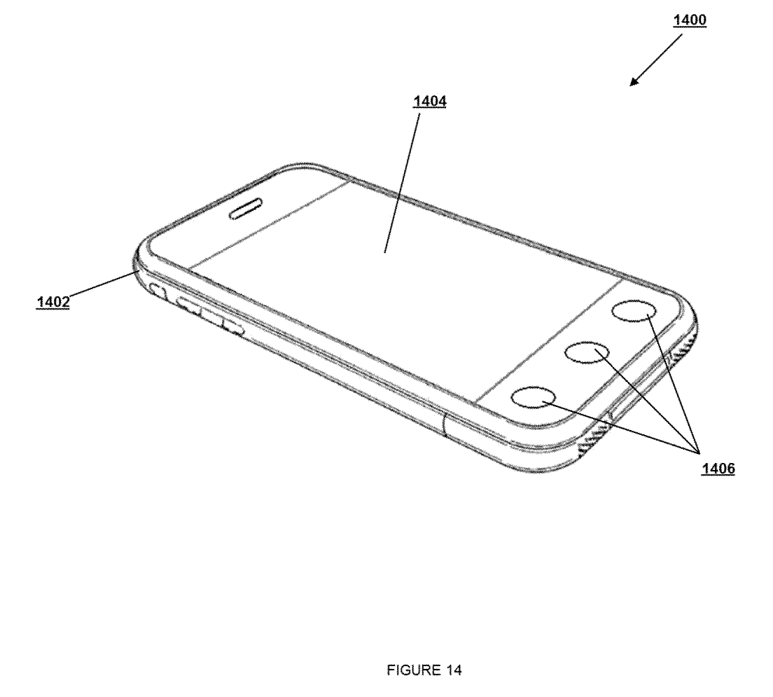

Referring now to FIG. 14, an embodiment of a sender device 1402 is illustrated. The sender device 1402 may be the first sender device 200 or the second sender device 700. The sender device 1400 includes a chassis 1402 having a display 1404 and an input device including the display 1404 and a plurality of input buttons 1406. One of skill in the art will recognize that the sender device 1400 is a portable or mobile phone including a touch screen input device and a plurality of input buttons that allow the functionality discussed above with reference to the method 100. However, a variety of other portable/mobile sender devices may be used in the method 100 without departing from the scope of the present disclosure.

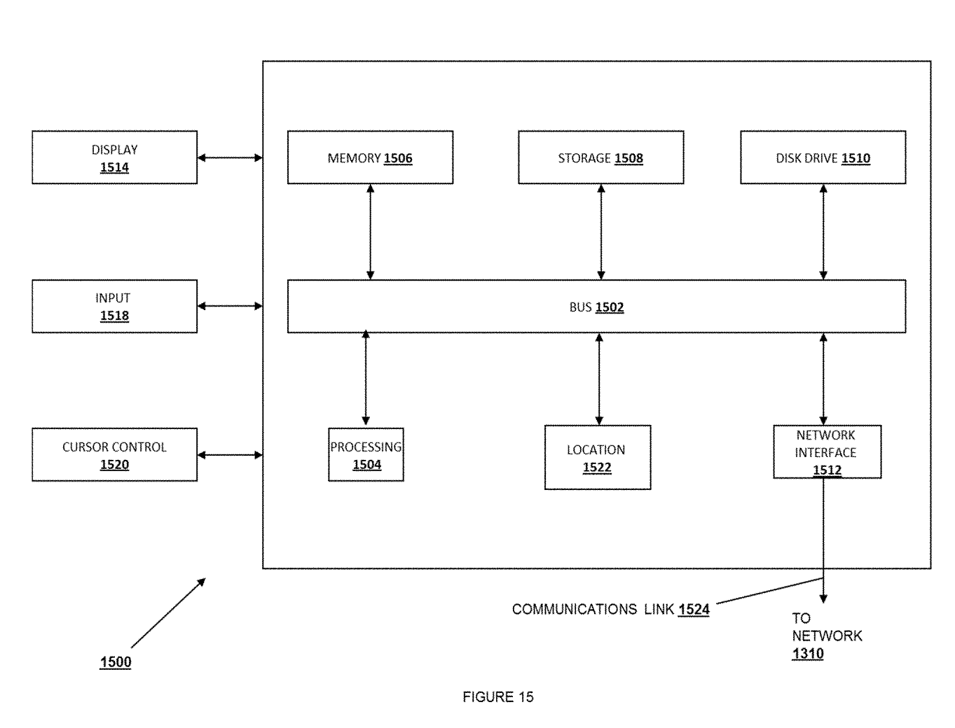

Referring now to FIG. 15, an embodiment of a computer system 1500 suitable for implementing, for example, the system provider devices 1000, first sender device 200, second sender device 700, and/or receiver device 1100, is illustrated. It should be appreciated that other devices utilized by users, persons, and/or system providers in the system discussed above may be implemented as the computer system 1500 in a manner as follows.

In accordance with various embodiments of the present disclosure, computer system 1500, such as a computer and/or a network server, includes a bus 1502 or other communication mechanism for communicating information, which interconnects subsystems and components, such as a processing component 1504 (e.g., processor, micro-controller, digital signal processor (DSP), etc.), a system memory component 1506 (e.g., RAM), a static storage component 1508 (e.g., ROM), a disk drive component 1510 (e.g., magnetic or optical), a network interface component 1512 (e.g., modem or Ethernet card), a display component 1514 (e.g., CRT or LCD), an input component 1518 (e.g., keyboard, keypad, or virtual keyboard), a cursor control component 1520 (e.g., mouse, pointer, or trackball), and a location sensor component 1522 (e.g., a Global Positioning System (GPS) device as illustrated, a cell tower triangulation device, and/or a variety of other location determination devices known in the art). In one implementation, the disk drive component 1510 may comprise a database having one or more disk drive components.

In accordance with embodiments of the present disclosure, the computer system 1400 performs specific operations by the processor 1504 executing one or more sequences of instructions contained in the memory component 1506, such as described herein with respect to the first sender device 200, the second sender device 700, the receiver devices 1100, and/or the system provider device(s) 1000. Such instructions may be read into the system memory component 1506 from another computer readable medium, such as the static storage component 1508 or the disk drive component 1510. In other embodiments, hard-wired circuitry may be used in place of or in combination with software instructions to implement the present disclosure.

Logic may be encoded in a computer readable medium, which may refer to any medium that participates in providing instructions to the processor 1504 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1510, volatile media includes dynamic memory, such as the system memory component 1506, and transmission media includes coaxial cables, copper wire, and fiber optics, including wires that comprise the bus 1502. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1500. In various other embodiments of the present disclosure, a plurality of the computer systems 1500 coupled by a communication link 1524 to the network 1310 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1400 may transmit and receive messages, data, information and instructions, including one or more programs (i.e., application code) through the communication link 1524 and the network interface component 1512. The network interface component 1512 may include an antenna, either separate or integrated, to enable transmission and reception via the communication link 1524. Received program code may be executed by processor 1504 as received and/or stored in disk drive component 1510 or some other non-volatile storage component for execution.

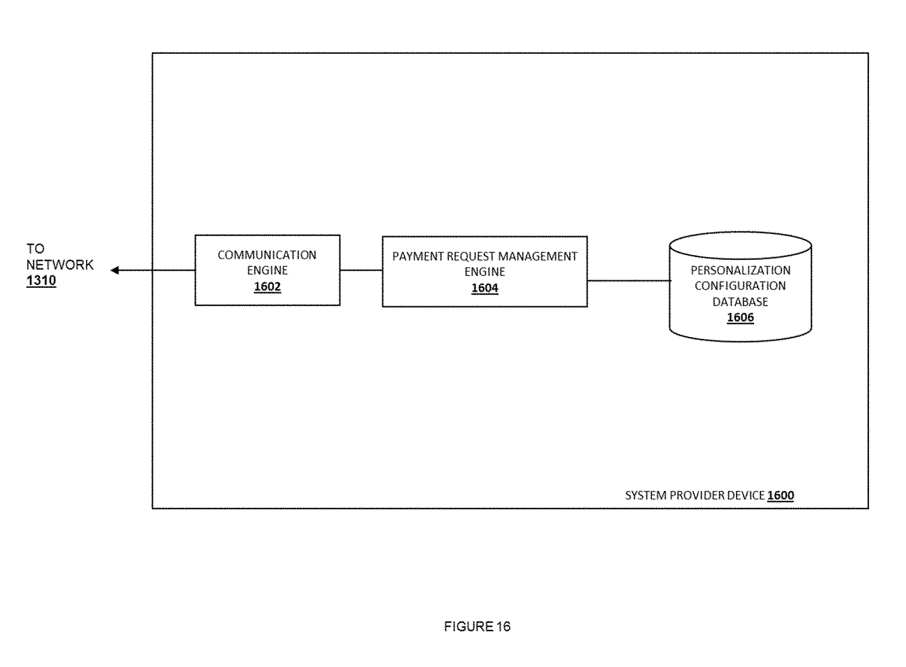

Referring now to FIG. 16, an embodiment of a system provider device 1600 is illustrated. In an embodiment, the system provider device 1600 may be the system provider devices 1000 discussed above. The system provider device 1600 includes a communication engine 1602 that is coupled to the network 1610 and to a payment management engine 1604 that is coupled to a personalization configuration database 1606. In an embodiment, the personalization configuration database 1606 may be the personalization configuration database discussed above with reference to FIGS. 4A, 4B, and 8. The communication engine 1602 may be software or instructions stored on a computer-readable medium that allows the system provider device 1600 to send and receive information over the network 1310. The payment management engine 1604 may be software or instructions stored on a computer-readable medium that is operable to receive a payment request associated with the first sender and a receiver, retrieve from the at least one database a personalization configuration associated with the payment request, determine a personalized payment message associated with the payment request according to the personalization configuration, communicating the payment request with the personalized message over the network that causes a display of the payment request with the personalized message on a receiver device associated with the receiver, and provide any of the other functionality that is discussed above. While the database 1606 has been illustrated as located in the system provider device 1600, one of skill in the art will recognize that the database 1606 may be connected to the payment management engine 1604 through the network 1310 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A payment request management system, comprising:
a non-transitory memory; and
one or more hardware processors coupled to the non-transitory memory and configured to read instructions from the non-transitory memory to cause the system to perform operations comprising:
receiving, through a network from a first sender device associated with a first sender, a payment request associated with the first sender and a receiver;
determining a personalization configuration associated with the payment request;
receiving, through the network from the first sender device, a personalized payment message according to the personalization configuration;
storing the personalized payment message in association with the payment request; and
communicating, through the network to a receiver device associated with the receiver, the payment request with the personalized payment message to cause a display of the payment request and playing of the personalized payment message on the receiver device.

2. The system of claim 1, wherein the personalized payment message includes at least one selected from the group consisting of audio content, video content, and music video content.

3. The system of claim 1, wherein the payment request is associated with a second sender, and wherein the operations further comprise:
receiving, through the network from the first sender device, a first sender personalized message;
receiving, through the network from a second sender device associated with the second sender, a second sender personalized message; and
generating the personalized payment message using the first sender personalized message and second sender personalized message according to the personalization configuration.

4. The system of claim 3, wherein the personalization configuration includes a group music video configuration, and wherein the operations further comprise:
generating a group music video message according to the group music video configuration.

5. The system of claim 4, wherein the operations further comprise:
assigning portions of a song to the first sender and the second sender according to the group music video configuration;
receiving, through the network from the first sender device, first group music video content associated with the portions of the song assigned to the first sender;
receiving, through the network from the second device, second group music video content associated with the portions of the song assigned to the second sender; and
consolidating the first group music video content and second group music video content according to the group music video configuration to generate the group music video message.

6. The system of claim 5, wherein the assigning portions of the song to the first sender and the second sender includes:
assigning a first portion of the song to the first sender;
assigning a second portion of the song to the send sender; and
assigning a third portion of the song to the first sender and the second sender.

7. The system of claim 4, wherein the group music video configuration is provided by the first sender.

8. A method, comprising:
receiving, by a system provider device through a network from a first sender device associated with a first sender, a payment request associated with the first sender and a receiver;
determining, by the system provider device, a personalization configuration associated with the payment request;
receiving, by the system provider device through the network from the first sender device, a personalized payment message according to the personalization configuration;
storing, by the system provider device, the personalized payment message in association with the payment request; and
communicating, by the system provider device through the network to a receiver device associated with the receiver, the payment request with the personalized payment message to cause a display of the payment request and playing of the personalized payment message on the receiver device.

9. The method of claim 8, wherein the personalized payment message includes at least one selected from the group consisting of audio content, video content, and music video content.

10. The method of claim 8, wherein the payment request is associated with a second sender, and wherein the method further comprises:
receiving, by the system provider device through the network from the first sender device, a first sender personalized message;
receiving, by the system provider device through the network from a second sender device associated with the second sender, a second sender personalized message; and
generating, by the system provider device, the personalized payment message using the first sender personalized message and second sender personalized message according to the personalization configuration.

11. The method of claim 10, wherein the personalization configuration includes a group music video configuration, and wherein the method further comprises:
generating, by the system provider device, a group music video message of the personalized payment message according to the group music video configuration.

12. The method of claim 11, further comprising:
assigning, by the system provider device, portions of a song to the first sender and the second sender according to the group music video configuration;
receiving, by the system provider device through the network from the first sender device, first group music video content associated with the portions of the song assigned to the first sender;
receiving, by the system provider device through the network from the second sender device, second group music video content associated with the portions of the song assigned to the second sender; and
consolidating, by the system provider device, the first group music video content and second group music video content according to the group music video configuration to generate the group music video message.

13. The method of claim 12, wherein the assigning portions of the song to the first sender and the second sender includes:
assigning, by the system provider device, a first portion of the song to the first sender;
assigning, by the system provider device, a second portion of the song to the send sender; and
assigning, by the system provider device, a third portion of the song to the first sender and the second sender.

14. The method of claim 11, wherein the group music video configuration is provided by the first sender.

15. A non-transitory machine-readable medium having stored thereon machine-readable instructions executable to cause a machine to perform operations comprising:
receiving, through a network from a first sender device associated with a first sender, a payment request associated with the first sender and a receiver;
determining a personalization configuration associated with the payment request;
receiving, through the network from the first sender device, a personalized payment message according to the personalization configuration;
storing the personalized payment message in association with the payment request configuration; and
communicating, through the network to a receiver device associated with the receiver, the payment request with the personalized payment message to cause a display of the payment request and playing of the personalized payment message on the receiver device.

16. The non-transitory machine-readable medium of claim 15, wherein the personalized payment message includes at least one selected from the group consisting of audio content, video content, and music video content.

17. The non-transitory machine-readable medium of claim 15, wherein the payment request is associated with a second sender, wherein the operations comprise:
receiving, through the network from the first sender device, a first sender personalized message;
receiving, through the network from a second sender device associated with the second sender, a second sender personalized message; and
generating the personalized payment message using the first sender personalized message and second sender personalized message according to the personalization configuration.

18. The non-transitory machine-readable medium of claim 17, wherein the personalization configuration includes a group music video configuration, and wherein the operations comprise:
generating a group music video message of the personalized payment message according to the group music video configuration.

19. The non-transitory machine-readable medium of claim 18, wherein the operations comprise:
assigning portions of a song to the first sender and the second sender according to the group music video configuration;
receiving, through the network from the first sender device, first group music video content associated with the portions of the song assigned to the first sender;
receiving, through the network from the second sender device, second group music video content associated with the portions of the song assigned to the second sender; and
consolidating the first group music video content and second group music video content according to the group music video configuration to generate the group music video message.

20. The non-transitory machine-readable medium of claim 19, wherein the assigning portions of the song to the first sender and the second sender includes:
assigning a first portion of the song to the first sender;
assigning a second portion of the song to the send sender; and
assigning a third portion of the song to the first sender and the second sender.
